(19) United States
(12) Patent Application Publication
(10) Pub. No.: US 2025/0258472 A1
(43) Pub. Date: Aug. 14, 2025

(54) SCADA WEB HMI SYSTEM

(71) Applicant: TOSHIBA MITSUBISHI-ELECTRIC INDUSTRIAL SYSTEMS CORPORATION, Tokyo (JP)

(72) Inventors: Ryo SHIMIZU, Tokyo (JP); Akira NOJIMA, Tokyo (JP); Nobuo SHIMIZU, Tokyo (JP)

(73) Assignee: TOSHIBA MITSUBISHI-ELECTRIC INDUSTRIAL SYSTEMS CORPORATION, Tokyo (JP)

(21) Appl. No.: 18/856,658

(22) PCT Filed: Mar. 14, 2023
(86) PCT No.: PCT/JP2023/009923

§ 371 Date: Oct. 14, 2024

(51) Int. Cl. G05B 19/05

(52) U.S. Cl. CPC G05B 19/052; G05B 2219/13144

(57) ABSTRACT

Each of PLCs transmits block data relating to a field device group constituting an industrial plant, to a SCADA server device at a fixed period. The SCADA server device includes a communication driver configured to receive the block data, and a client management circuitry connected to a plurality of HMI client devices in one-to-one relationship and configured to perform WebSocket communication with each of the HMI client devices. Each of the HMI client devices executes a web browser displaying an HMI screen on which parts indicating states of the industrial plant are arranged, and updates states of the parts based on signal data received from the client management circuitry. Each of the HMI client devices includes a client installer for installing a SCADA web program loaded at startup of the web browser.

### TECHNICAL FIELD

The present invention relates to a SCADA web HMI system, and in particular to a technique for reducing a processing load in a large-scale system.

### BACKGROUND ART

A SCADA (Supervisory Control And Data Acquisition) is known as a mechanism supervising and controlling a social infrastructure system. The social infrastructure system may be a steel rolling system, a power transmission and transformation system, a water and sewage treatment system, a building management system, a road system, or the like. The SCADA is a type of industrial control system, and performs system supervision, process control, and data collection by a computer. The SCADA needs quick responsiveness (real-time property) corresponding to processing performance of the system.

The SCADA generally includes the following sub-systems.

### (1) HMI (Human Machine Interface)

An HMI is a mechanism that presents data on a supervisory object device to an operator, and enables the operator to supervise and control the supervisory object device.

### (2) Supervisory Control System

A supervisory control system includes a Programmable Logic Controller (PLC) and the like. The supervisory control system collects the data on the supervisory object device, and transmits a control command to the supervisory object device.

### (3) Remote Input/Output Device (Remote Input Output: RIO)

A remote input/output device is connected to a sensor installed in the supervisory object device, converts a signal of the sensor into digital data, and transmits the digital data to the supervisory control system.

### (4) Communication Base

A communication base connects the supervisory control system and the remote input/output device.

As an example of a SCADA HMI sub-system, PTL 1 discloses a system including an HMI client device and a SCADA server device. In the existing SCADA such as disclosed in PTL 1, the SCADA server device transmits data (input/output signals, and alarm signal) received from the PLC to the HMI client device. The input/output signals are signals relating to the supervisory object device (field device group constituting industrial plant), and include an actuator control signal and a sensor detection signal.

### CITATION LIST

### Patent Literature

[PTL 1] JP 2017-27211 A

### SUMMARY OF THE INVENTION

### Problems to be Solved by the Invention

Issues in development of the HMI sub-system that is one of the above-described sub-systems are described.

In the large-scale system, the HMI sub-system connects two hundred thousand or more signals to the PLC in some cases. The existing SCADA server device performing both of supervisory control and data collection needs a high-performance processor and a large-capacity memory in order to process the large number of signals in real time. Therefore, it is desirable to realize the HMI sub-system applicable to the large-scale system, at low cost.

To realize low cost of the SCADA HMI sub-system, the inventor of the present application has developed a browser-based SCADA HMI sub-system. This makes it possible to realize an HMI screen as a web application operating on a web browser.

One of advantages of realization of the HMI screen on the web browser is easy acquisition of data from different web servers by switching a URL (including port number). In other words, data on a history screen can be acquired from an online data gathering (ODG) device that collects and accumulates all of PLC data, and data on a supervisory screen required to have real-time property can be acquired from the SCADA server device. A function relating to the history that is a part of SCADA functions is separated and is taken on by the online data gathering device, which enables the SCADA server device to specialize in a real-time supervisory function. To process the large number of signals by the low-cost SCADA server device, it is desirable to reduce a processing load for the input/output signals (including actuator control signal and sensor detection signal) and the alarm signal.

In the large-scale SCADA web HMI system, it is anticipated that a large number of (for example, 128) client devices are connected to one SCADA server device. In addition, even in a case of a redundant design in which two SCADA server devices are provided to distribute the load, a large number of HMI client devices are connected to each of the SCADA server devices. In a case where the same HMI screen is displayed on a monitor of each of the HMI client devices, it is necessary for the SCADA server device to receive signal data included in the HMI screen and to transmit the signal data to all of the HMI client devices. In the browser-based SCADA HMI sub-system, the HMI screen on each of the HMI client devices is displayed by a web browser, and the signal data is transmitted from the SCADA server device to the HMI client devices by using Point to Point connection such as WebSocket. In other words, multicast transmission cannot be used for transmission from the SCADA server device to the HMI client devices. Accordingly, in the case where 128 client devices are connected to the SCADA server device, it is necessary for the SCADA server device to transmit the signal data of 128 times a received data amount to the HMI client devices. As described above, during system operation (during supervision of industrial plant), a large amount of data flows between the SCADA server device and each of the HMI client devices.

The web application generally downloads a program operating on the web browser, from the SCADA server device, and executes the program. In other words, a SCADA web program is necessary for the web browser on each of the HMI client devices, and the SCADA web program is loaded from the SCADA server device through WebSocket. As illustrated in FIG. 12, in a case where the web browser starts up on each of the HMI client devices before start of system operation, even when the SCADA web program is loaded to the web browsers of all HMI client devices through WebSocket, a communication traffic between the HMI client devices and the SCADA server device is less than a communication capacity limit (communication capability), and there is no problem for system operation. In contrast, in a case where the web browser starts up during system operation, a communication error in which the communication traffic exceeds communication capability of the network may occur, or it takes time to load a web content. In this case, a time period when the industrial plant cannot be supervised occurs, which affects system operation.

The present invention is made to solve the above-described issues, and an object of the present invention is to provide a SCADA web HMI system that can prevent a communication traffic between HMI client devices and a SCADA server device from exceeding communication capability even in a case where web browsers start up during system operation.

### Solution to Problem

A first aspect of the present disclosure relates to a SCADA web HMI system. The SCADA web HMI system comprises a plurality of programmable logic controllers (hereinafter, PLCs), a plurality of HMI client devices, and a SCADA server device that are connected to one another through a computer network. Each of the PLCs transmits block data relating to a field device group constituting an industrial plant, to the SCADA server device at a fixed period. The SCADA server device includes a communication driver configured to receive the block data, and a client management unit connected to the plurality of HMI client devices in one-to-one relationship and configured to perform WebSocket communication with each of the HMI client devices. Each of the HMI client devices executes a web browser displaying an HMI screen on which parts indicating states of the industrial plant are arranged, and updates states of the parts based on signal data received from the client management unit to supervise the industrial plant. Each of the HMI client devices includes a client installer for installing a SCADA web program loaded at startup of the web browser.

A second aspect further includes the following characteristics in addition to the first aspect. The SCADA server device includes a client installer same as the client installer. The client installer is downloaded from the SCADA server device to each of the HMI client devices through the client management unit by using the web browser before the industrial plant is supervised.

A third aspect further includes the following characteristics in addition to the first or second aspect. The SCADA server device includes a communication module including a content operated by the SCADA web program. Each of the HMI client devices loads the communication module from the SCADA server device. The web browser exchanges data between the SCADA web program operating in a domain of the own HMI client device and the communication module operating in a domain of the SCADA server device, through inter-domain communication.

A fourth aspect further includes the following characteristics in addition to the first or second aspect. The SCADA server device downloads application-dependent data that is data depending on an application operated by the SCADA web program, and transmits the downloaded application-dependent data to each of the HMI client devices. When the SCADA server device is connected to each of the HMI client devices, the SCADA server device determines whether the SCADA web program has been updated, and only in a case where the SCADA web program has been updated, the SCADA server device transmits the application-dependent data to the HMI client device.

A fifth aspect further includes the following characteristics in addition to the first or second aspect. When the SCADA web program is connected to the SCADA server device, each of the HMI client devices transmits a revision of the application-dependent data held by the SCADA web program, to the SCADA server device. The SCADA server device performs the determination by comparing the revision received from each of the HMI client devices with a revision of the downloaded application-dependent data.

### Advantageous Effects of the Invention

According to the present disclosure, the client installer is provided in each of the HMI client devices. Therefore, at startup of the web browser, the SCADA web program is loaded not from the SCADA server device through WebSocket but from the own HMI client device. Thus, even in the case where the web browser starts up during system operation, it is possible to prevent the communication traffic between the HMI client devices and the SCADA server device from exceeding communication capability.

### BRIEF DESCRIPTION OF DRAWINGS

FIG. 1 is a diagram to explain a configuration example of a SCADA web HMI system according to an Embodiment of the present invention.

FIG. 2(a) is a diagram to explain data types of signal data. FIG. 2(b) is a diagram to explain identifiers of signal data.

FIG. 3(a) is a diagram to explain format of signal data. FIG. 3(b) is a diagram to explain format of screen update data.

FIG. 4 is a diagram to explain process in a client management unit of a SCADA server device.

FIG. 5 is a diagram to explain a system for loading a SCADA web program.

FIG. 6 is a diagram to explain previously distribution of client installer to an HMI client device.

FIG. 7 is a diagram to explain a system for loading a communication module.

FIG. 8 is a diagram to explain another system for loading the communication module.

FIG. 9 is a diagram to explain a system for loading application-dependent data.

FIG. 10 is a flowchart to explain a method for loading the application-dependent data.

FIG. 11 is a block diagram illustrating an example of a hardware configuration of the SCADA server device and the HMI client device.

FIG. 12 is a diagram to explain conventional problem.

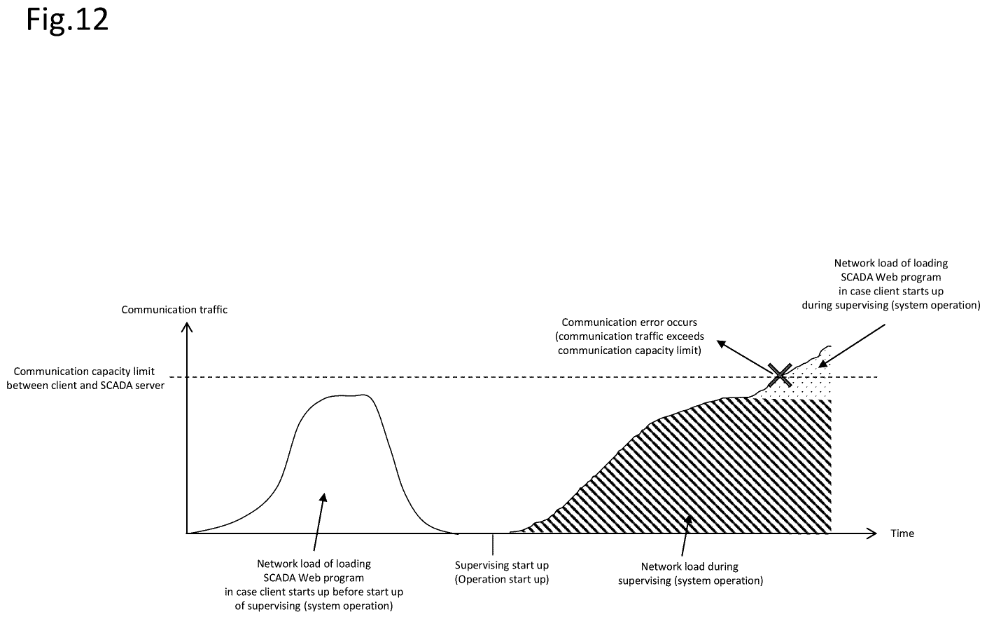

### DESCRIPTION OF EMBODIMENT

An embodiment of the present invention is described in detail below with reference to drawings. Note that elements common to the drawings are denoted by the same reference numerals, and repetitive description is omitted.

### 1-1. SCADA Web HMI System

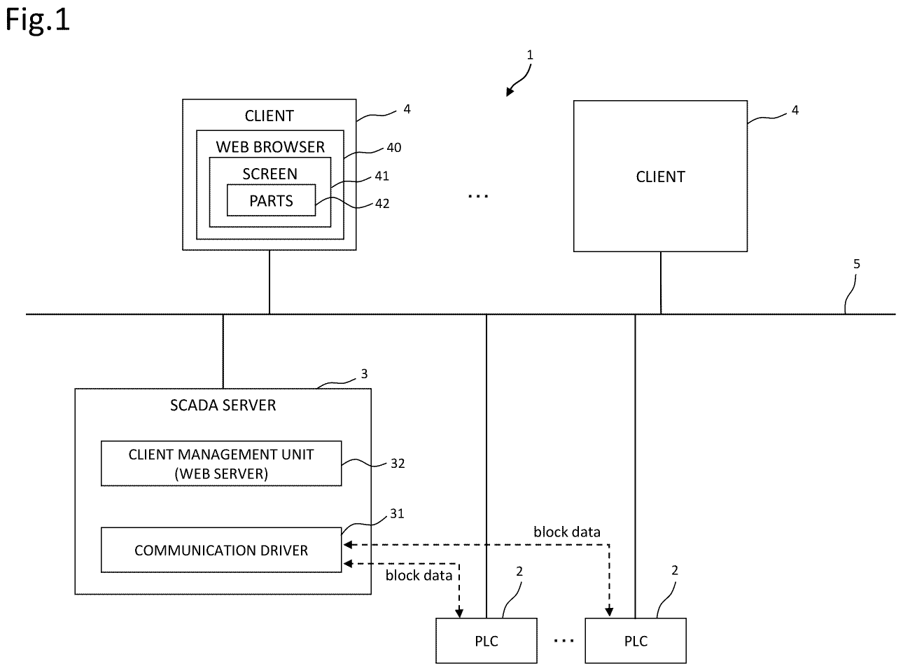

FIG. 1 is a diagram to explain a configuration example of a SCADA web HMI system according to Embodiment 1. A SCADA web HMI system 1 illustrated in FIG. 1 includes PLCs 2, a SCADA server device 3, and HMI client devices 4 that are mutually connected through a computer network 5. The computer network 5 is, for example, Ethernet®. The SCADA web HMI system 1 may include an unillustrated online data gathering (ODG) device.

The PLCs 2 are connected to a field device group (including actuator and sensor) constituting an industrial plant through an unillustrated control network. Each of the PLCs 2 transmits a packet including block data to the computer network 5 by multicast or broadcast at a fixed period. The block data is a set of PLC signals. One piece of block data includes several tens to several hundred PLC signals. As types of the PLC signals, there are input/output signals (including actuator control signal and sensor detection signal), and an alarm signal. The block data includes at least one of a set of input/output signals and a set of alarm signals. The total number of alarm signals is less than the total number of input/output signals.

The block data is periodically transmitted irrespective of whether a value of each of the PLC signals is changed from a previous value. Therefore, even in a case where the transmitted packet including the block data is lost, the packet is retransmitted in a next transmission period, and the latest state is reflected on the SCADA server device 3 and the online data gathering device.

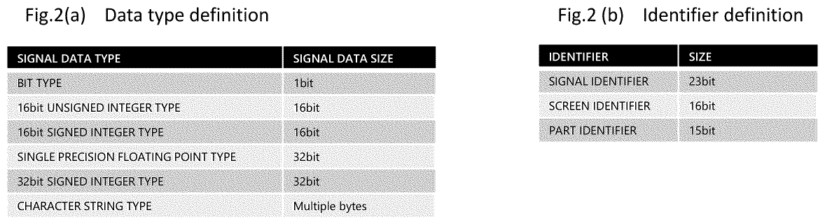

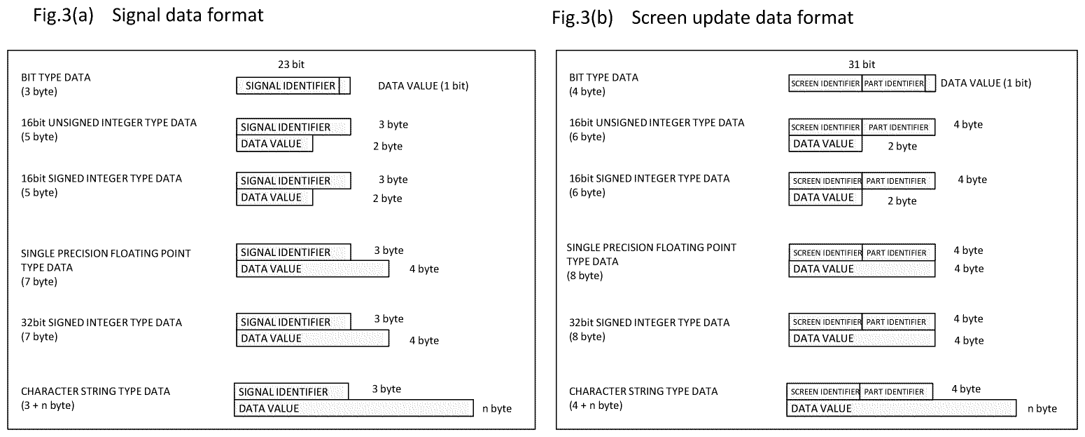

The SCADA server device 3 includes a communication driver 31 and a client management unit 32. The communication driver 31 is configured to receive the block data from each of the PLCs 2 at the fixed period, and to perform unpack processing for decomposing the received block data into signal data for each data type. As the data types, a short type, a float type, and the like are usable in addition to a bit type illustrated in FIG. 2(a). The communication driver 31 is also configured to perform packet processing for generating a packet for each data type by adding a corresponding signal data identifier (see FIG. 2(b)) to each piece of the signal data, and transmitting the generated packet to the client management unit 32. In other words, the signal data transmitted from the communication driver 31 to the client management unit 32 is a pair of the signal data identifier and a value of the signal data (see FIG. 3(a)).

The signal data identifier corresponds to a character string described by an application designer. A data size of the signal data identifier is, for example, 23 bits. Therefore, the signal data identifier can represent about eight million pieces of signal data, and can sufficiently support the large-scale SCADA web HMI system 1. In a case of the bit-type data, the signal data identifier is 23 bits, and the value of the data is 1 bit. Therefore, the data size per one signal is 24 bits (=3 bytes). In a case of the float-type data, the signal data identifier is 23 bits, and the value of the data is 4 bytes. Therefore, a padding of 1 bit is added, and the data size per one signal is 7 bytes. Note that, when the packet is generated, only the signal data having the signal data identifier relating to an HMI screen 41 currently displayed on a web browser 40 may be extracted.

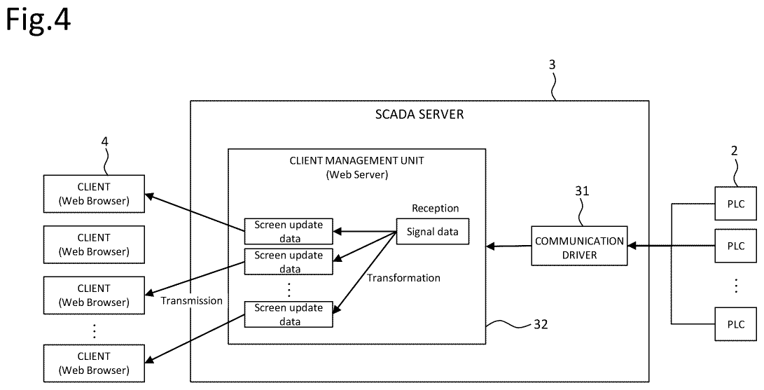

The client management unit 32 includes a signal data reception thread, at least one signal data buffer, and a signal data transmission thread. The signal data reception thread receives the packet (signal data for each data type) received from the communication driver 31, and stores the signal data in the signal data buffer. The signal data buffer includes regions (arrays) storing the signal data for the respective data types. Even if eight million pieces of signal data are present, the memory usage is allowable in consideration of the specification of the current computer because the memory usage is about 24 Mbytes except for the text type. Further, using an index makes it possible to reduce the data amount stored in the signal data buffer. When receiving an instruction from the signal data reception thread, the signal data transmission thread reads out the signal data stored in the signal data buffer, and transmits the read signal data for each data type to the HMI client devices 4. At this time, the signal data transmission thread transmits a screen identifier indicating the HMI screen 41 and a part identifier indicating each part 42 illustrated in FIG. 3(b), and the updated signal data as screen update data to the HMI client devices 4 (see FIG. 4). As illustrated in FIG. 2 to FIG. 4, binarizing the signal data makes it possible to reduce the data amount transmitted to the HMI client devices 4.

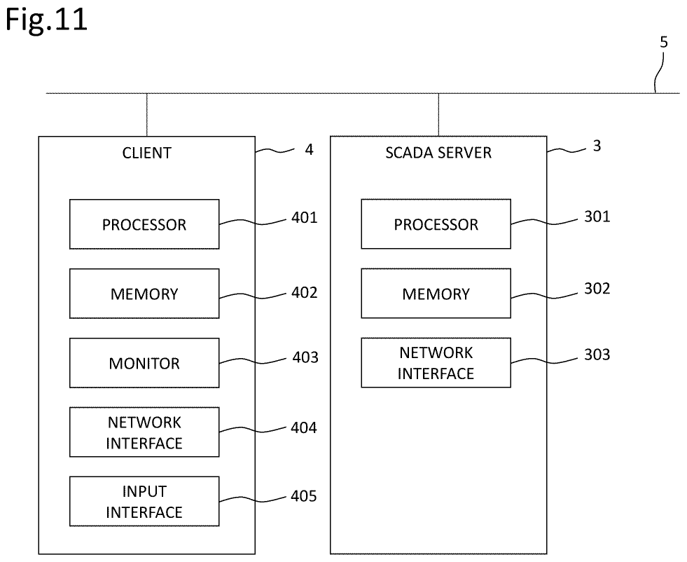

As illustrated in FIG. 11 described below, the SCADA server device 3 includes a processor 301 performing various kinds of processing, a memory 302 storing various kinds of information, and a network interface 303. The SCADA server device 3 is configured to perform various kinds of processing described above and below when the processor 301 executes programs stored in the memory 302.

Each of the HMI client devices 4 includes a processor 401, a memory 402, a monitor 403, a network interface 404, and an input interface 405 that are illustrated in FIG. 11 described below. The processor 401 is configured to execute the web browser 40 displaying the HMI screen 41 on which display parts are arranged, by executing programs stored in the memory 402. The monitor 403 displays the web browser 40.

The web browser 40 can change a connection destination (SCADA server device 3 or online data gathering device 4) based on a URL, and acquire various kinds of information on an HTML document relating to the HMI screen 41, from a web server designated by the URL. The HMI screen 41 includes a supervisory screen required to have real-time property, and a history screen displaying history data.

In a case where the HMI screen 41 currently displayed on the web browser 40 is the supervisory screen, the web browser 40 changes display states of the display parts 42 based on the input/output signals received from the SCADA server device 3. Change of the display states indicates, for example, change in numerical values, characters, a color, and a shape. Further, the web browser 40 changes the display states of the alarm part 42 arranged on the HMI screen 41 based on the alarm signal received from the SCADA server device 3.

In a case where the screen 41 currently displayed on the web browser 40 is the history screen, the web browser 40 requests history data to the online data gathering device. The web browser 40 displays the history data received from the online data gathering device on the history screen.

Although not illustrated, the online data gathering device includes a processor and a memory. The processor is configured to perform web server processing and history data management processing by executing programs stored in the memory. The online data gathering device periodically receives block data from the PLCs 2. In the history data management processing by the online data gathering device, history data on all signals included in the received block data is accumulated in the memory (including database). In the web server processing by the online data gathering device, history data is transmitted in response to a request from the web browser 40. Further, the online data gathering device receives an alarm packet from the SCADA server device 3, and accumulates the alarm packet.

### 1-2. System for Loading SCADA Web Program

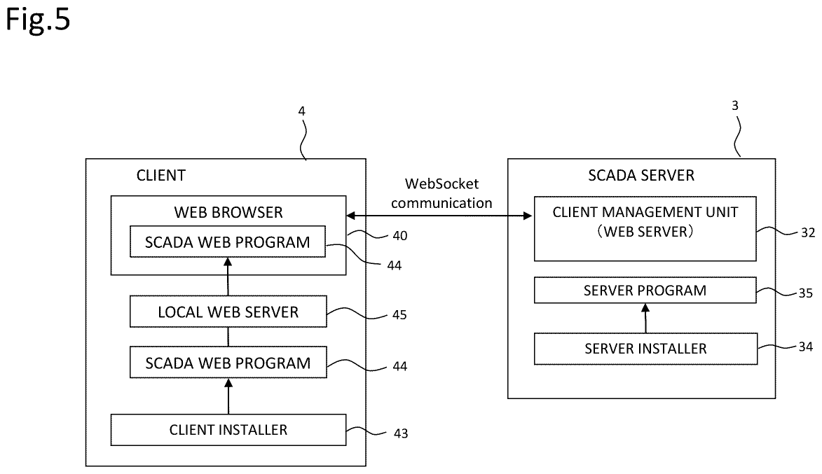

FIG. 5 is a diagram to explain a system for loading a SCADA web program. As illustrated in FIG. 5, each of the HMI client devices 4 includes a client installer 43. The client installer 43 operates at a timing when the SCADA web program is updated, and deploys a local web server 45 and a SCADA web program 44 in the own client device 4. The web browser 40 can load the SCADA web program through the local web server 45 at startup. Therefore, unlike an existing case where the SCADA web program 44 is loaded from the SCADA server device 3, a communication band between each of the HMI client devices 4 and the SCADA server device 3 is fully allocated to the communication traffic during system operation.

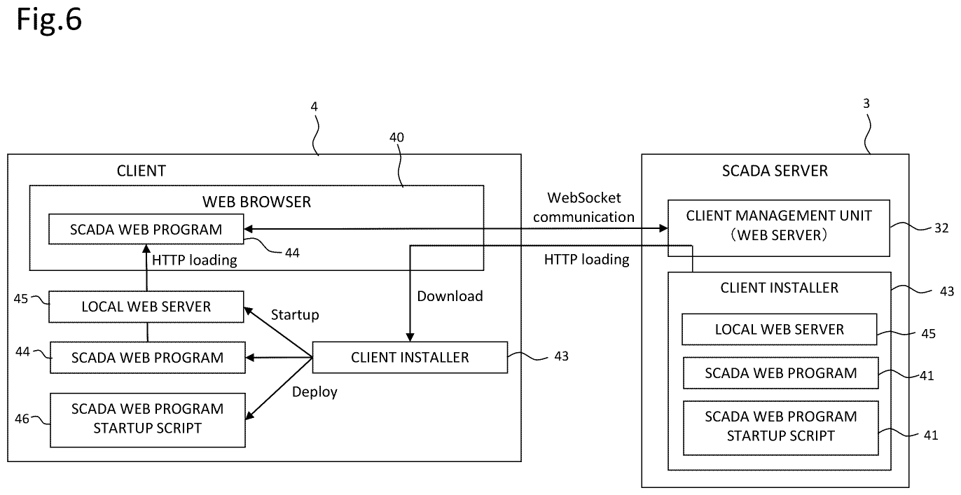

To install the client installer 43 in each of the HMI client devices 4, a CD-ROM may be used; however, as illustrated in FIG. 6, the client installer 43 is previously distributed (by HTTP loading) from the SCADA server device 3 to each of the HMI client devices 4, which makes it possible to reduce time and effort for installing the client installer 43 and to suppress an operation cost. In other words, the SCADA server device 3 includes the client installer 43. The client installer 43 includes the local web server 45, the SCADA web program 44, and a SCADA web program startup script 46 operating in each of the client devices 4. Accordingly, a system operation administrator can download the client installer 43 from the SCADA server device 3 only by using the web browser 40. When the client installer 43 is executed in each of the HMI client devices 4, the local web server 45 starts up in each of the HMI client devices 4, and the SCADA web program 44 and the SCADA web program startup script 46 are arranged in each of the client devices 4. At this time, a shortcut linked to the SCADA web program startup script 46 is arranged on a Window® desktop of the monitor 403. Therefore, the operator can load the SCADA web program 44 on the web browser 40 only by double-clicking the shortcut. The SCADA web program startup script 46 includes a communication address of the SCADA server device 3. The SCADA web program 44 is automatically connected to the SCADA server device 3, and the operator can promptly start supervision of the system.

### 1-3. System for Loading Communication Module

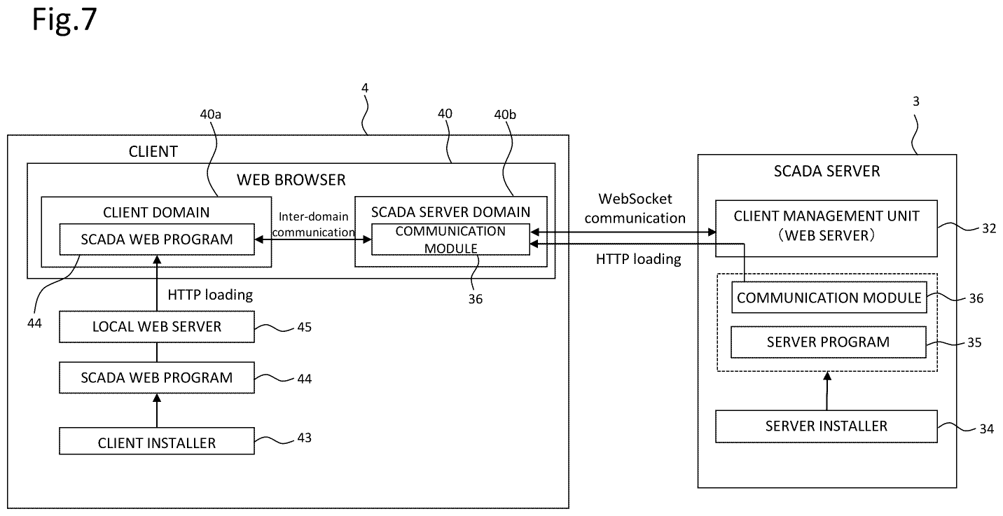

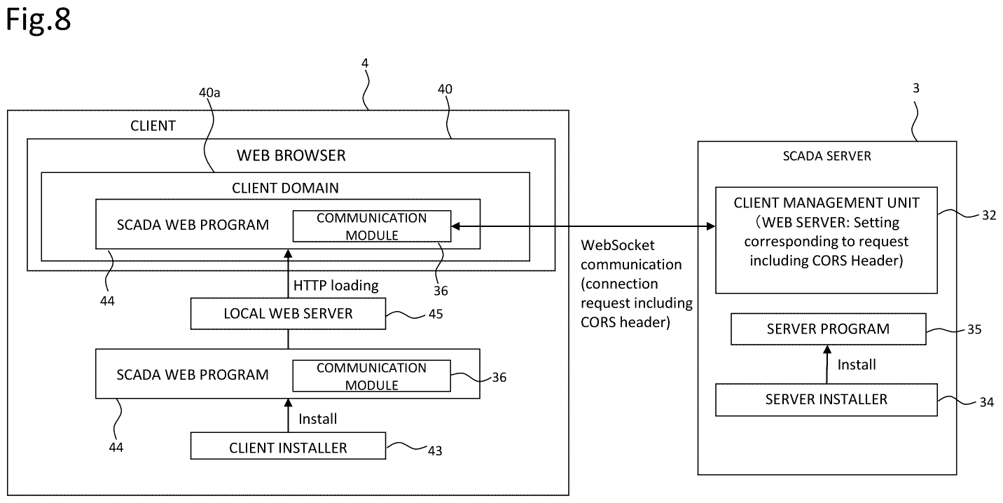

FIG. 7 is a diagram to explain a system for loading a communication module. FIG. 8 is a diagram to explain another system for loading the communication module.

A communication module 36 provides a function necessary for the SCADA web program 44 to communicate with the server. This kind of communication module 36 is required to be loaded not from the local web server 45 but from the SCADA server device 3. The SCADA server device 3 includes a server installer 34. When the server installer 34 starts up, a server program 35 and the communication module 36 are arranged in the SCADA server device 3. It is necessary for the communication module 36 to perform WebSocket communication with the client management unit 32 on the SCADA server device 3; however, the communication module 36 is required to operate in a domain 40b of the SCADA server device 3 for a security reason called same-origin policy. In other words, the communication module 36 is required to be loaded from the client management unit 32 on the SCADA server device 3. Thus, as illustrated in FIG. 7, data is exchanged between the SCADA web program 44 operating in a domain 40a on the web browser 40 of each of the HMI client devices 4 and the communication module 36 operating in the domain 40b of the SCADA server device 3, through inter-domain communication. As another method, as illustrated in FIG. 8, when CORS (Cross Domain Resource Sharing) is set to the SCADA server device 3, the SCADA server device 3 can accept communication connection from another domain. This enables previous installation of the communication module 36 in each of the HMI client devices 4. As a result, it is possible to further reduce the communication load between each of the HMI client devices 4 and the SCADA server device 3.

### 1-4. System for Loading Application-Dependent Data

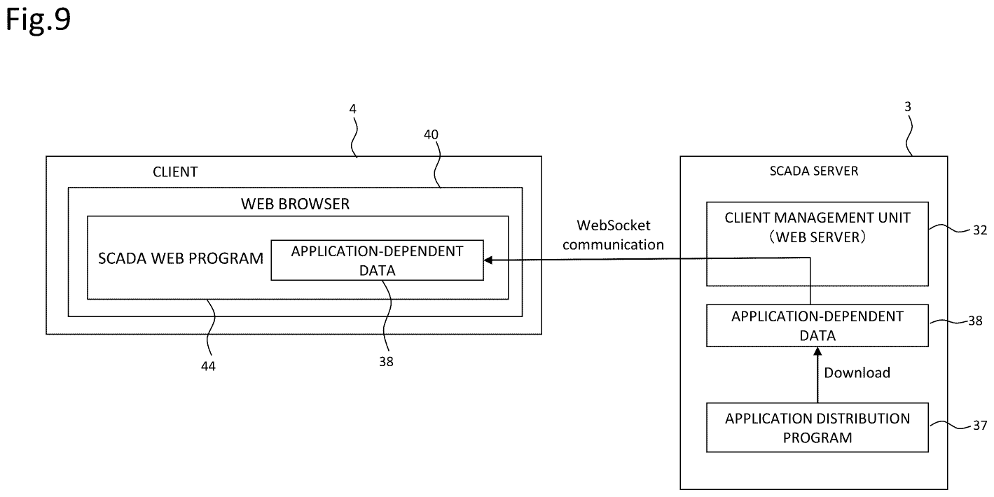

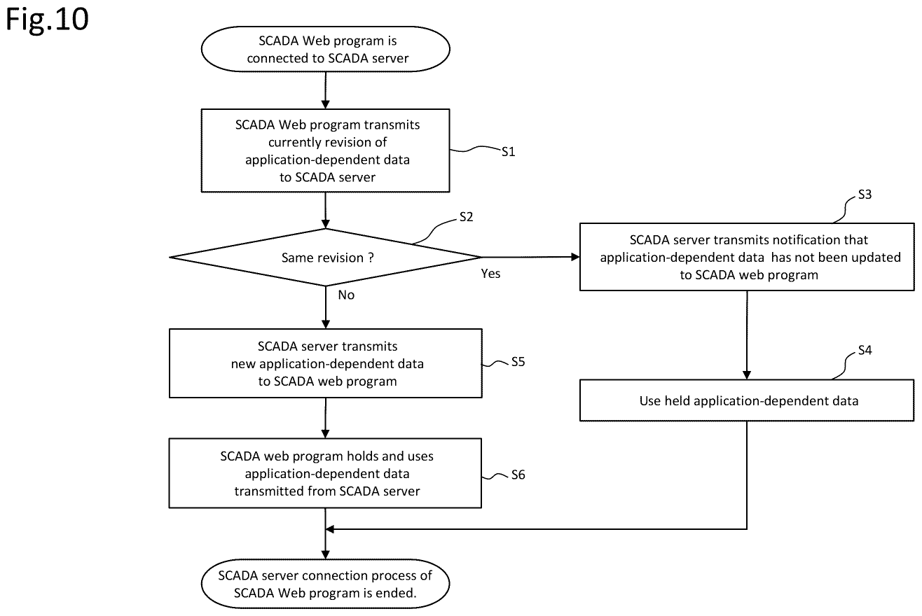

FIG. 9 is a diagram to explain a system for loading application-dependent data. FIG. 10 is a flowchart to explain a method for loading the application-dependent data.

To operate the SCADA web program 44, it is necessary to load application-dependent data 38 depending on an application, to the web browser 40. The application-dependent data 38 is downloaded to the SCADA server device 3 by an application distribution program 37. The application-dependent data 38 includes an application revision, and is transmitted to each of the HMI client devices 4 only in a case where the application-dependent data 38 is updated as described below. At a time when the SCADA web program 44 on each of the HMI client devices 4 is connected to the client management unit 32, a routine illustrated in FIG. 10 starts up. In the routine, the SCADA web program 44 transmits the application revision of the application-dependent data 38 currently held, to the SCADA server device 3 (step S1). The SCADA server device 3 compares the application revision of the downloaded application-dependent data 38 with the application revision transmitted in step S1 (step S2). In a case where the application revisions are the same as a result of comparison, the SCADA server device 3 transmits a notification that the application-dependent data 38 has not been updated to the SCADA web program 44 (step S3). Thereafter, the SCADA web program 44 uses the held application-dependent data 38 (step S4), and the routine ends.

In contrast, in a case where the application revisions are different from each other, in other words, in a case where the application-dependent data 38 has been updated, the SCADA server device 3 transmits new application-dependent data 38 to the SCADA web program 44 (step S5). Thereafter, the SCADA web program 44 holds and uses the transmitted application-dependent data 38 (step S6), and the routine ends.

The application-dependent data 38 is not changed unless the application is updated. Therefore, the application-dependent data 38 once transmitted to each of the HMI client devices 4 is stored in each of the HMI client devices 4. Only in a case where the application is updated, the application-dependent data 38 is transmitted to each of the HMI client devices 4, which makes it possible to reduce the communication load between each of the HMI client devices 4 and the SCADA server device 3.

### 1-5. Effects

As described above, according to the present embodiment, the client installer 43 is provided in each of the HMI client devices 4. Therefore, at startup of the web browser 40, the SCADA web program 44 is loaded not from the SCADA server device 3 through HTTP, but from the own HMI client device 4. Thus, even in the case where the web browser 40 starts up during system operation, it is possible to prevent the communication traffic between the HMI client devices 4 and the SCADA server device 3 from exceeding communication capability. This prevents a communication error from occurring during system operation and reduces a loading time of a web content, which makes it possible to eliminate a time period when the industrial plant cannot be supervised.

### 2. Hardware Configuration Example

FIG. 11 is a block diagram illustrating hardware configuration examples of the SCADA server device 3 and each of the HMI client devices 4.

The processing of the above-described SCADA server device 3 is realized by a processing circuit. The processing circuit includes the processor 301, the memory 302, and the network interface 303 that are connected to one another. The processor 301 realizes the functions of the SCADA server device 3 by executing various kinds of programs stored in the memory 302. The memory 302 includes a main storage device and an auxiliary storage device.

The processing of each of the above-described HMI client devices 4 is realized by a processing circuit. The processing circuit includes the processor 401, the memory 402, at least one monitor 403, the network interface 404, and the input interface 405 that are connected to one another. The processor 401 realizes the functions of the own HMI client device 4 by executing various kinds of programs stored in the memory 402. The memory 402 includes a main storage device and an auxiliary storage device. The input interface 405 is an input device such as a keyboard, a mouse, and a touch panel. A plurality of monitors 403 may be provided.

Although the embodiment of the present invention is described above, the present invention is not limited to the above-described embodiment, and can be variously modified and implemented without departing from the spirit of the present invention. When numerals of the number, the quantity, the amount, the range, and the like of each of the elements are mentioned in the above-described embodiment, the present invention is not limited to the mentioned numerals except for the case of being particularly clearly mentioned and the case of being obviously specified to the numerals in principle. Further, the structure and the like described in the above-described embodiment are not necessarily essential for the present invention except for the case of being particularly clearly mentioned and the case of being obviously specified to the structure and the like in principle.

### REFERENCE SIGNS LIST

1 . . . . SCADA web HMI system, 2 . . . . Programmable Logic Controller (PLC), 3 . . . . SCADA server device, 31 . . . communication driver, 32 . . . client management unit, 36 . . . communication module, 37 . . . application distribution program, 38 . . . application-dependent data, 4 . . . . HMI client device, 40 . . . web browser, 41 . . . . HMI screen, 42 . . . part, 43 . . . client installer, 44 . . . . SCADA web program, 45 . . . local web server, 46 . . . program startup script, 5 . . . computer network, 301,401 . . . processor, 302,402 . . . memory, 403 . . . monitor, 304,404 . . . network interface, 405 . . . input interface

1. A SCADA web HMI system comprising a plurality of programmable logic controllers (hereinafter, PLCs), a plurality of HMI client devices, and a SCADA server device that are connected to one another through a computer network, wherein
each of the PLCs transmits block data relating to a field device group constituting an industrial plant, to the SCADA server device at a fixed period,
the SCADA server device includes a communication driver configured to receive the block data, and client management circuitry connected to the plurality of HMI client devices in one-to-one relationship and configured to perform WebSocket communication with each of the HMI client devices,
each of the HMI client devices executes a web browser displaying an HMI screen on which parts indicating states of the industrial plant are arranged, and updates states of the parts based on signal data received from the client management circuitry to supervise the industrial plant,
each of the HMI client devices includes a client installer for installing a SCADA web program loaded at startup of the web browser,
the SCADA server device downloads application-dependent data that is data depending on an application operated by the SCADA web program, and transmits the downloaded application-dependent data to each of the HMI client devices, and
when the SCADA server device is connected to each of the HMI client devices, the SCADA server device determines whether the SCADA web program has been updated, and only in a case where the SCADA web program has been updated, the SCADA server device transmits the application-dependent data to the HMI client device.

2. The SCADA web HMI system according to claim 1, wherein
the SCADA server device includes a client installer same as the client installer, and
the client installer is downloaded from the SCADA server device to each of the HMI client devices through the client management circuitry by using the web browser before the industrial plant is supervised.

3. The SCADA web HMI system according to claim 1, wherein
the SCADA server device includes a communication module including a content operated by the SCADA web program,
each of the HMI client devices loads the communication module from the SCADA server device, and
the web browser exchanges data between the SCADA web program operating in a domain of the own HMI client device and the communication module operating in a domain of the SCADA server device, through inter-domain communication.

4. (canceled)

5. The SCADA web HMI system according to claim 1, wherein
when the SCADA web program is connected to the SCADA server device, each of the HMI client devices transmits a revision of the application-dependent data held by the SCADA web program, to the SCADA server device, and
the SCADA server device performs the determination by comparing the revision received from each of the HMI client devices with a revision of the downloaded application-dependent data.

6. The SCADA web HMI system according to claim 2, wherein
the SCADA server device includes a communication module including a content operated by the SCADA web program,
each of the HMI client devices loads the communication module from the SCADA server device, and
the web browser exchanges data between the SCADA web program operating in a domain of the own HMI client device and the communication module operating in a domain of the SCADA server device, through inter-domain communication.

7. The SCADA web HMI system according to claim 2, wherein
when the SCADA web program is connected to the SCADA server device, each of the HMI client devices transmits a revision of the application-dependent data held by the SCADA web program, to the SCADA server device, and
the SCADA server device performs the determination by comparing the revision received from each of the HMI client devices with a revision of the downloaded application-dependent data.

8. The SCADA web HMI system according to claim 3, wherein
when the SCADA web program is connected to the SCADA server device, each of the HMI client devices transmits a revision of the application-dependent data held by the SCADA web program, to the SCADA server device, and
the SCADA server device performs the determination by comparing the revision received from each of the HMI client devices with a revision of the downloaded application-dependent data.

9. The SCADA web HMI system according to claim 5, wherein
when the SCADA web program is connected to the SCADA server device, each of the HMI client devices transmits a revision of the application-dependent data held by the SCADA web program, to the SCADA server device, and
the SCADA server device performs the determination by comparing the revision received from each of the HMI client devices with a revision of the downloaded application-dependent data.

10. The SCADA web HMI system according to claim 6, wherein
when the SCADA web program is connected to the SCADA server device, each of the HMI client devices transmits a revision of the application-dependent data held by the SCADA web program, to the SCADA server device, and
the SCADA server device performs the determination by comparing the revision received from each of the HMI client devices with a revision of the downloaded application-dependent data.
